(19) United States
(12) Patent Application Publication
(10) Pub. No.: US 2009/0243304 A1
(43) Pub. Date: Oct. 1, 2009

(54) SYSTEMS AND METHODS FOR CAPTURING LINEAR MOTION FOR CONVERSION TO ENERGY

(76) Inventor: Norbert J. Stein, Sandy, UT (US)

Correspondence Address: HOLLAND & HART LLP, 60 E. South Temple, Suite 2000, P.O. Box 11583, Salt Lake City, UT, 84110, US

(21) Appl. No.: 12/410,700

(22) Filed: Mar. 25, 2009

Related U.S. Application Data
(60) Provisional application No. 61/039,283, filed on Mar. 25, 2008.

(51) Int. Cl. F02B 63/04; H02K 7/06

(52) U.S. Cl. 290/1 C

(57) ABSTRACT

Systems and methods are provided for capturing linear motion and converting it to energy may augment existing power grids, and may be installed in existing infrastructure. In some examples, a system may be installed in a roadway to capture the linear motion of automobiles, so that it may be converted first to rotational motion, then to energy. In other examples, systems may be installed in railways, sidewalks or other areas to capture and convert linear motion from trains, bicycles, walkers and other moving objects. In yet other examples, the linear motion from a package moving along a series of spindles arranged linearly may be captured and eventually converted to energy.

### FIELD OF THE INVENTION

The instant disclosure relates generally to the field of capturing linear motion for conversion to energy.

### BACKGROUND

Many systems and methods exist for using energy sources, such as wind, water, solar, nuclear and steam, to generate electricity. Nonetheless, as energy consumption increases, so does the need for new energy sources.

With over 200 million passenger cars in the United States alone that drive approximately 2.5 trillion miles per year, there exists a largely unexploited market and opportunity to harness the energy generated by vehicles for use in energy generation. Thus, there is a need for a system and method of capturing linear motion for conversion to energy.

### SUMMARY

Certain embodiments may include systems and methods for capturing linear motion and converting it to energy. In at least one embodiment, the systems and methods augment existing power grids, and may be installed in existing infrastructure.

In some embodiments, the system may be installed in a roadway to capture the linear motion of automobiles, so that it may be converted first to rotational motion, then to energy. In certain embodiments, the system may be installed in railways, sidewalks or other areas to capture and convert linear motion from trains, bicycles, walkers and other moving objects.

In at least one embodiment, the linear motion from a package moving along a series of spindles arranged linearly may be captured and eventually converted to energy.

At least one embodiment may comprise a system and method for capturing linear motion and converting the linear motion to energy. The system and method comprise a linear motion capture mechanism, a linear-to-rotational motion converter that is connected to the linear motion capture mechanism and an energy generator that is connected to the linear-to-rotational motion converter. In certain embodiments, the linear motion capture mechanism comprises a plate that is biased upwards in relation to a substantially planar surface.

Some embodiments include an elongate member that has a first end and a second end, where the first end is connected to the linear motion capture mechanism and the second end is connected to the linear-to-rotational motion converter. In at least one embodiment, the linear-to-rotational motion converter comprises a gear that rotates when engaged by the second end of the elongate member. Certain embodiments include a transmission member that connects the linear-to-rotational motion converter and the energy generator.

In at least one embodiment, the linear motion capture converter may further comprise a pressure tank, a piston, and a substance disposed within the pressure tank. In some embodiments, the piston is configured to displace a portion of the substance through an opening in the tank and actuate the linear-to-rotational motion converter.

In certain embodiments, the linear motion capture mechanism and the linear-to-rotational motion converter comprise a first set of one or more spindles. In at least one embodiment, the one or more spindles are removable from a planar surface.

Certain embodiments include a second set of one or more spindles, where the second set of one or more spindles are connected to and configured to transfer rotational motion to the first set of one or more spindles. In some embodiments, a flexible connecting member connects the linear-to-rotational motion converter and the energy generator. In many embodiments, the energy generator generates an electrical current. Certain embodiments include an energy transmitter coupled with the energy generator.

In some embodiments, the method of capturing linear motion and converting the linear motion to energy comprises providing a linear motion capture mechanism, coupling a linear-to-rotational motion converter with the linear motion capture mechanism, and coupling an energy generator with the linear-to-rotational motion converter.

Certain embodiments include providing a linear motion capture mechanism that includes providing a linear motion capture mechanism having a plate that is biased upwards in relation to a substantially planar surface.

Some embodiments include providing an elongate member having a first end and a second end, coupling the first end to the linear motion capture mechanism and coupling the second end to the linear-to-rotational motion converter.

In at least one embodiment, the method includes actuating the linear-to-rotational motion converter by displacing the second end of the elongate member.

In certain embodiments, the coupling of an energy converter with the linear-to-rotational motion converter includes coupling the energy converter and the linear-to-rotational motion converter with a belt.

In some embodiments, the method includes configuring the linear motion capture converter to include a pressure tank, a piston and a substance disposed within the pressure tank. In at least one embodiment, the method further comprises displacing a portion of the substance through an opening of the pressure tank by the piston to actuate the linear-to-rotational motion converter.

In certain embodiments, the method includes configuring the linear motion capture mechanism and the linear-to-rotational motion converter to include a first set of one or more spindles.

In at least one embodiment, the method of generating power includes capturing linear motion from a moving object, converting linear motion to rotational motion and converting rotational motion to energy.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

FIG. 1 is a schematic diagram showing an example system for capturing linear motion and converting it to energy.

FIG. 2 depicts an example system installed in a roadway.

FIG. 3 depicts a side view of one embodiment which uses downward pressure to rotate a gear.

FIG. 4 depicts a side view of another embodiment which uses pressurized fluid to rotate a gear.

FIG. 5 depicts a side view of another embodiment which uses rotating spindles to capture linear motion.

FIG. 6 depicts an embodiment similar to that shown in FIG. 5, wherein the spindles are part of a removable unit which may be temporarily installed in a roadway.

FIG. 7 depicts another embodiment similar to that shown in FIG. 5, wherein the spindles are permanently installed in a roadway.

FIG. 8 depicts an example device for transferring rotational motion.

FIG. 9 depicts an embodiment wherein a spindle is installed in a roadway with bearings.

FIG. 10 depicts an embodiment having a plurality of spindles aligned in a track.

FIG. 11 depicts an example of energy being transferred to an automobile.

### DETAILED DESCRIPTION OF VARIOUS EMBODIMENTS

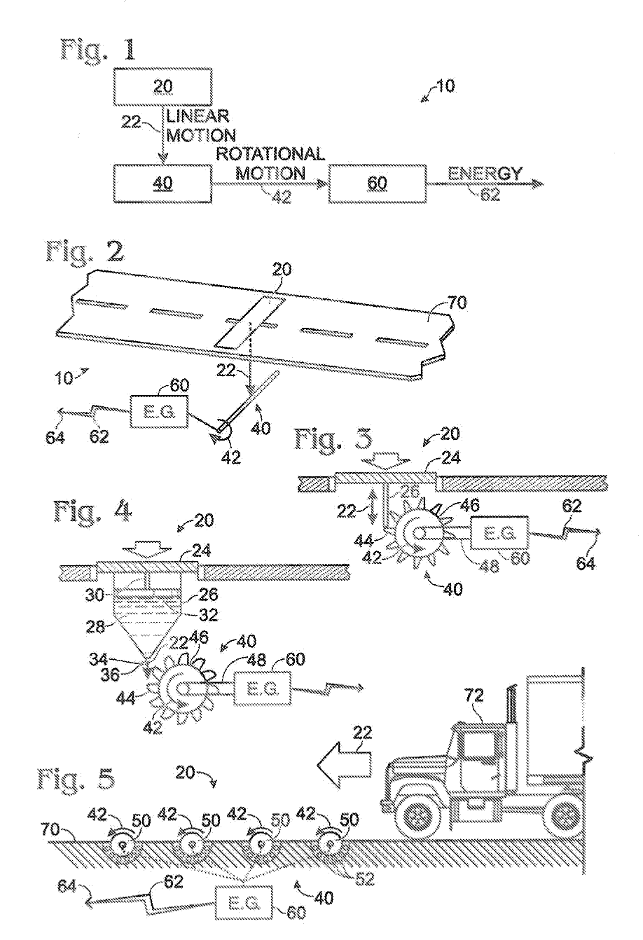

An example system 10 for capturing linear motion and converting it to energy is shown in FIG. 1. System 10 may include a linear motion capture mechanism 20, a linear-to-rotational motion converter 40 and an energy generator 60.

Linear motion capture mechanism 20 captures linear motion 22 from a moving object. A moving object may be, for example, an automobile moving on a roadway, a package moving along a track of spindles in a warehouse, a train moving along a railway, a bicycle moving on a roadway or sidewalk, a person walking on a sidewalk or the like.

Linear motion capture mechanism 20 may provide captured linear motion 22 to linear-to-rotational motion converter 40, which may be configured to convert linear motion 22 to rotational motion 42. Linear-to-rotational motion converter 40 may take various forms, as will be discussed below. In some embodiments, linear-to-rotational motion converter 40 may be a turbine having blades adapted to receive linear motion 22 provided by linear motion capture mechanism 20 to spin the turbine, creating rotational motion.

Rotational motion 42 may be converted into energy 62, such as electrical current 64 (FIG. 2), by energy generator 60. Energy generator 60 may include one or more magnets (not shown). Rotational motion 42 may be used, for example, to rotate or spin the one or more magnets relative to a conductor, such as a coiled wire (not shown). Voltage is induced in the conductor, causing energy 62 in the form of electrical current 64 (typically alternating current, though direct current is generated in some embodiments) to be produced. Electrical current 64 may be used immediately, or it may be harvested and stored for later use in a battery or other similar device.

FIG. 2 illustrates generally how an example system 10 may be implemented on a roadway 70 or other substantially planar surface. Linear motion capture mechanism 20 is shown as a white box to indicate that it may take various forms which will be discussed in more detail below. Linear motion capture mechanism 20 captures linear motion from automobiles driving on the road and provides it to linear-to-rotational motion converter 40, which converts captured linear motion 22 to rotational motion 42. Rotational motion 42 is provided to energy generator 60, which converts the rotational motion to energy 62 in the form of electrical current 64.

FIGS. 3-5 depict three different examples of linear motion capture mechanism 20. In FIG. 3, linear motion capture mechanism 20 includes a movable plate 24 which may be nominally biased upwards. As shown by the white arrow, a vehicle or other object passing over movable plate 24 biases movable plate 24 downwards, causing an elongate member 26 to contact and bias downwards a tooth 44 of a gear 46. This downward bias on tooth 44 causes gear 46 to rotate in the direction of rotational motion 42. In this example, a belt 48 or other transmission member is coupled to gear 46 for transferring rotational motion 42 to energy generator 60.

In FIG. 4, linear motion capture mechanism 20 includes a movable plate 24 which may be nominally biased upwards, similar to movable plate 24 of FIG. 3. In this example, linear motion capture mechanism 20 also includes a pressure tank 26 at least partially filled with a substance 28 such as a gas or fluid. A piston 30 having a planar end 32 shaped to fit within pressure tank 26 is coupled to movable plate 24, so that when movable plate 24 is biased downwards (e.g., by the weight of a passing automobile), piston 30 is moved downwards. The downward motion of piston 30 causes planar end 32 to press down on substance 28, creating pressure within pressure tank 26. A valve 34 may be configured to prevent substance 28 from escaping pressure tank 26 while substance 28 is at or below a particular pressure. Valve 34 may also be configured to open when substance 28 is above a particular pressure, allowing substance 28 to be released in the form of a pressurized stream 36. Pressurized stream 36 may then exert force upon tooth 44 of gear 46, or assist in actuating some other mechanism, creating rotational motion 42. Put another way, pressurized stream 36 is the linear motion 22 which is converted by linear-to-rotational motion converter 40 (which in this example takes the form of gear 46, although other devices may be used) to rotational motion 42, which is transferred to energy generator 60 by belt 48.

In FIG. 5, linear motion capture mechanism 20 and linear-to-rotational motion converter 40 are contained within a single component. A series of spindles 50 may be installed into roadway 70 so that when an automobile 72 runs over each spindle 50, the linear motion 22 of the automobile is captured and converted to rotational energy 42 in the form of the spinning of spindle 50. Spindles 50 may turn in the same direction as the automobile 72 travels, or, alternatively, spindles 50 may turn in the opposite direction. As shown in dotted lines, rotational motion 42 is provided to energy generator 60 for conversion to energy 62. In some embodiments, such as the one shown in FIG. 5, spindles 50, or at least a portion thereof, are laid in a bed of bearings 52, to allow for ease of rotation. In certain embodiments, spindles 51 transfer rotational motion 42 to energy generator 60.

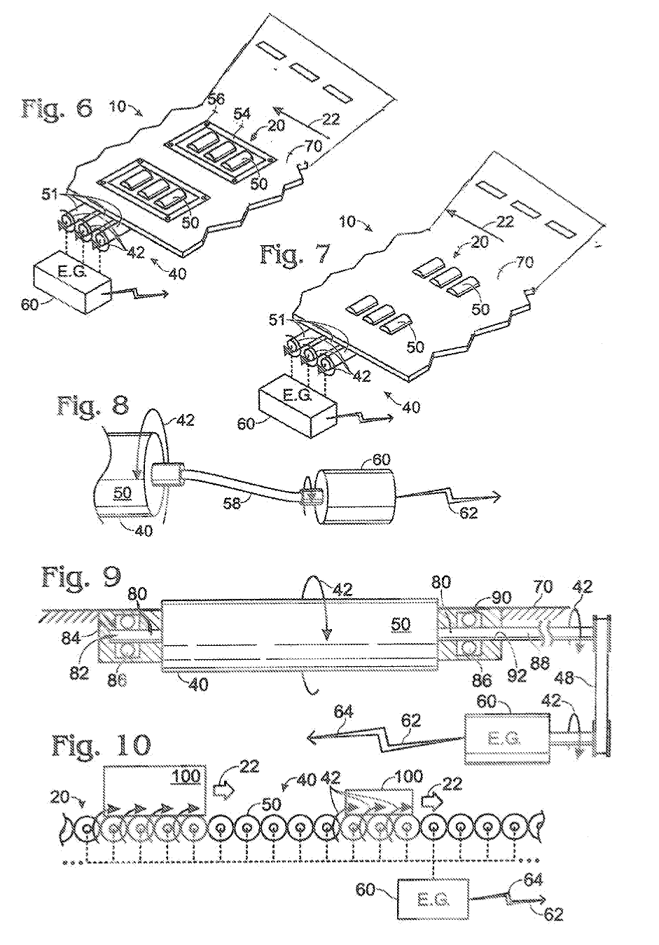

FIGS. 6 and 7 depict two embodiments similar to that shown in FIG. 5. Each embodiment includes a series of spindles 50 installed in roadway 70. The installation of FIG. 6 is temporary, as shown by the portable unit 54 housing one or more spindles 50. Portable unit 54 may be affixed to roadway 70 using fastener 56, which may be a bolt, screw or the like. Portable unit 54 provides the capability of quick and easy repositioning of system 10 to different positions. Other components may also be configured for quick repositioning, as will be discussed below.

The system 10 of FIG. 7 is similar to that shown in FIG. 6, except that spindles 50 are shown more permanently installed in roadway 70. In both FIGS. 6 and 7, each spindle 50 shown above roadway 70 is operatively coupled (e.g., via teeth or other similar members, not shown) to a lower spindle 51. Lower spindle 51 functions similarly to spindle 50, and merely serves as an example of how rotational motion 42 may be transferred from the level of roadway 70 to a location beneath roadway 70.

FIG. 8 depicts one manner of transferring rotational motion between two components that are offset from one another. Linear-to-rotational motion converter 40, which in FIG. 8 takes the form of spindle 50, is not concentric with energy generator 60. Therefore, spindle 50 is operatively connected to energy generator 60 via a flexible connecting member 58. Flexible connecting member 58 may be, for example, a cable, belt or the like. Both ends of flexible connecting member 58 connected to spindle 50 and energy generator 60, respectively, are affixed to those components so that the ends cannot rotate relative to those components. Accordingly, when spindle 50 provides rotational motion 42, rotational motion 42 is transferred from spindle 50 to energy converter 60 via the twisting of flexible connecting member 58 in the same direction as rotational motion 42.

The embodiment shown in FIG. 8, in combination with or separately from the embodiment shown in FIG. 6, provides the capability of quick and easy installation and removal of system 10, as well as the flexibility to place energy converter 60 at many different locations. For example, energy converter 60 may be placed on the surface of roadway 70 and flexible connecting member 58 may extend through an opening in roadway 70 to spindle 50. Having energy converter 60 on the surface of roadway 70 allows for quick replacement, if for example a more efficient energy converter 60 becomes available, or if the rotational motion 42 provided by spindle 50 is to be used for a different purpose, such as powering a street light.

FIG. 9 depicts a variation of the embodiments shown in FIGS. 5-8. In this embodiment, spindle 50 includes an axle 80 having a smaller diameter than the main body portion of the spindle 50. A first end 82 of axle 80 is installed into a first chamber 84 containing a plurality of bearings 86. A second end 88 of axle 80 is installed into a second chamber 90 containing a plurality of bearings 86. Bearings 86 may be immersed in a lubricant such as oil to allow bearings 86, or may be otherwise lubricated, to rotate with little resistance relative to their housing and the axle 80. Rotational motion 42 provided by spindle 50 causes axle 80 to similarly rotate among bearings 86.

While the first end 82 of axle 80 terminates in or near first chamber 84, second chamber 90 includes an opening 92 through which second end 88 of axle 80 may extend to provide rotational motion 42 to energy converter 60. In this embodiment, second end 88 of axle 80 terminates at a gear or pulley at one end of belt 48. Belt 48 or other transmission member provides rotational motion 42 to energy converter 60.

Another embodiment is shown in FIG. 10. A series of spindles 50 are shown arranged in sequence to form a track upon which items such as packages 100 may be transported between locations. Such arrangements are commonly found in warehouses and shipment centers. Linear motion 22 is provided to spindles 50 from the movement of packages 100 along the track defined by the arrangement of spindles 50. Linear motion 22 is converted to rotational motion 42 by spindles 50. Each spindle 50 is shown operatively coupled to energy converter 60 via a dotted line, which represents the transfer of rotational motion 42 exhibited by spindle 50 to energy converter 60. Rotational motion 42 may be transferred from spindles 50 to energy converter 60 using, for example, any of the methods and devices described above.

In the examples described above, energy converter 60 typically converts rotational motion 42 to energy 62 such as electrical current 64. As mentioned above, energy 62 may be used for various purposes. In some embodiments, energy may be provided to cars powered at least in part by electricity.

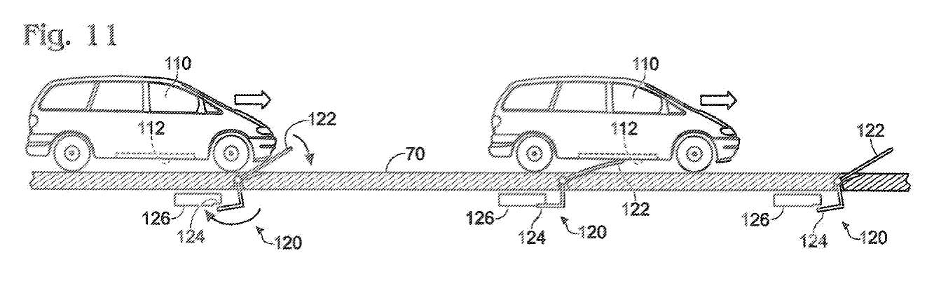

FIG. 11 depicts such an example. An automobile 110 (which could be a car, truck, train or any other moving carriage which is powered at least in part by electricity) has on its undercarriage a contact 112. An energy transmitter may be coupled with, for example, an energy converter 60 or some other source of energy. Such an energy transmitter may include a fulcrum 120 provided, for example, in roadway 70. In the embodiment shown, a first end 122 of fulcrum 120 is above the surface of roadway 70 and may be biased upwards. A second end 124 of fulcrum 120 may be below the surface of roadway 70 and may be biased downwards.

As automobile 110 moves along roadway 70, its undercarriage may contact first end 122 of fulcrum 120, displacing it downwards. The downwards displacement of first end 122 causes second end 124 to be displaced upwards to contact a power source 126. Power source 126 may be a source of power such as an electrical grid, a power plant, a battery or an energy converter 60 as described above. Fulcrum 120 may contain conductive materials, so that when second end 124 is in contact with power source 126 at the same time first end 122 is in contact with contact 112 on the undercarriage of automobile 110, a circuit is formed, and electrical power is transferred from power source 126 to a battery or other energy device in automobile 110.

Because the amount of time that the circuit is formed from power source 126 to automobile 110 may be brief, a series of fulcrums 120 may be installed in roadway 70. Such a series may provide more periods of time in which a battery in automobile 110 may be charged. Similarly, in some embodiments, contact 112 on the undercarriage of automobile 110 may extend along the length of the car, so that the second end 124 of fulcrum 120 may be in contact for a longer period of time, allowing for more electricity to be transferred to automobile 110. In at least one embodiment, the fulcrum 120 remains in contact with automobile 110 while the automobile 110 is parked.

Accordingly, while embodiments have been particularly shown and described with reference to the foregoing disclosure, many variations may be made therein. The foregoing embodiments are illustrative, and no single feature or element is essential to all possible combinations that may be used in a particular application. Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A system for capturing linear motion and converting the linear motion to energy comprising:
a linear motion capture mechanism;
a linear-to-rotational motion converter that is connected to the linear motion capture mechanism; and
an energy generator that is connected to the linear-to-rotational motion converter.

2. The system of claim 1, wherein the linear motion capture mechanism comprises a plate that is biased upwards in relation to a substantially planar surface.

3. The system of claim 1, further comprising an elongate member having a first end and a second end, wherein the first end is connected to the linear motion capture mechanism and the second end is connected to the linear-to-rotational motion converter.

4. The system of claim 3, wherein the linear-to-rotational motion converter comprises a gear that rotates when engaged by the second end of the elongate member.

5. The system of claim 1, further comprising a transmission member that connects the linear-to-rotational motion converter and the energy generator.

6. The system of claim 2, wherein the linear motion capture converter further comprises:
a pressure tank;
a piston; and
a substance disposed within the pressure tank;
wherein the piston is configured to displace a portion of the substance through an opening in the tank and actuate the linear-to-rotational motion converter.

7. The system of claim 1, wherein the linear motion capture mechanism and the linear-to-rotational motion converter comprise a first set of one or more spindles.

8. The system of claim 7, wherein the one or more spindles are removable from a substantially planar surface.

9. The system of claim 7, further comprising a second set of one or more spindles, wherein the second set of one or more spindles are connected to and configured to transfer rotational motion to the first set of one or more spindles.

10. The system of claim 1, further comprising a flexible connecting member connected between the linear-to-rotational motion converter and the energy generator.

11. The system of claim 1, wherein the energy generator generates an electrical current.

12. The system of claim 1, further comprising an energy transmitter coupled with the energy generator.

13. A method for capturing linear motion and converting the linear motion to energy comprising:
providing a linear motion capture mechanism;
coupling a linear-to-rotational motion converter with the linear motion capture mechanism; and
coupling an energy generator with the linear-to-rotational motion converter.

14. The method of claim 13, wherein providing a linear motion capture mechanism includes providing a linear motion capture mechanism having a plate that is biased upwards in relation to a substantially planar surface.

15. The method of claim 13, further comprising providing an elongate member having a first end and a second end, coupling the first end to the linear motion capture mechanism and coupling the second end to the linear-to-rotational motion converter.

16. The method of claim 15, further comprising actuating the linear-to-rotational motion converter by displacing the second end of the elongate member.

17. The method of claim 13, wherein coupling an energy converter with the linear-to-rotational motion converter includes coupling the energy converter and the linear-to-rotational motion converter with a belt.

18. The method of claim 13, further comprising configuring the linear motion capture converter to include:
a pressure tank;
a piston; and
a substance disposed within the pressure tank;
wherein the method further comprises displacing a portion of the substance through an opening of the pressure tank by the piston to actuate the linear-to-rotational motion converter.

19. The method of claim 13, further comprising configuring the linear motion capture mechanism and the linear-to-rotational motion converter to include a first set of one or more spindles.

20. A method of generating power comprising:
capturing linear motion from a moving object;
converting linear motion to rotational motion; and
converting rotational motion to energy.
